(19) United States
(12) Patent Application Publication
(10) Pub. No.: US 2016/0140220 A1
(43) Pub. Date: May 19, 2016

(54) METHOD FOR AUTOMATIC THEMATIC CLASSIFICATION OF A DIGITAL TEXT FILE

(71) Applicant: PROXEM, Paris (FR)

(72) Inventor: FRANÇOIS-RÉGIS CHAUMARTIN, CLICHY (FR)

(21) Appl. No.: 14/898,141

(22) PCT Filed: Jun. 4, 2014
(86) PCT No.: PCT/EP2014/061535

§ 371 Date: Dec. 13, 2015

(30) Foreign Application Priority Data
Jun. 14, 2013 (FR) 1355596

(51) Int. Cl. G06F 17/30

(52) U.S. Cl. CPC G06F 17/30707; G06F 17/30958

(57) ABSTRACT

A thematic classification method for a digital text file from an encyclopedic database comprising a category graph. A thematic classification model is developed during a learning phase. For each category node, all articles directly linked to the category node is grouped to obtain, for each category node, a “bag of words.” A term-frequency vector characteristic of the category node is determined. At each category node the term-frequency vector, directly connected thereto, with term-frequency vectors of more specific nodes are combined. During the production phase, the term-frequency vector of the digital text file is calculated. N category nodes in the thematic classification model having the closest term-frequency vectors to the term-frequency of the digital text file are selected.

### TECHNICAL FIELD OF THE INVENTION

The invention relates to an automatic thematic classification method for a digital text file. The invention thus relates to the field of information technology applied to language.

### TECHNICAL BACKGROUND

Categorization is the process of associating one or more predefined categories (or tags) with a given document. The objective of an automatic categorization of texts is to automatically infer a classification by analyzing their content. The very nature of predefined categories varies according to the objectives; it can be a matter of identifying the language of a text, the topics broached, but also for example the desired prioritization in processing the document, or the feelings expressed. The difficulty of the task depends on the type and length of the document: a tweet, an email, a news article, a scientific paper or a consumer opinion are generally not analyzed in the same way.

In addition, the categorization of a digital text file usually requires a significant investment at an upstream level with an adaptation that depends on the application domain. Indeed, the preliminary operational steps for learning a classification are most often: i) making up a classification plan, ii) manually annotating a learning corpus, iii) defining linguistic features used by a learning algorithm. These operations can be time consuming and their result is generally applicable only to the particular field concerned by the predefined categories, and to the types of documents representing the learning corpus.

Methods from machine learning to categorization are known. Thus, document Sebastiani, 2002 “Machine learning in automated Text Categorization”, in ACM Computing Surveys, Vol. 34, No. 1, pages 1-47, provides a comparison table of possible methods and applications. Document Dasari, 2012 “Text Categorization and Machine Learning Methods: Current State of the Art”, GJCST, Vol. 12, No. 11, adds more recent approaches to this state of the art and is an indication of the progress made within 10 years.

A question arises about classification plans, usually defined for a particular field. In fact, it is necessary to know which predefined set of categories would be sufficient for categorizing any given text in a reasonably generic way.

The categories of the online database “Wikipedia” have recently emerged as a possibility of such a universal classification plan. Document Schönhofen, P, 2009, “Identifying document topics using the Wikipedia category network”, Web Intelligence and Agent Systems, Vol. 7, No. 2, pages 195-207, thus proposes to use them to make a thematic categorization with a simple algorithm that simply exploits the titles and categories of the articles. A similar idea is presented in document Yun et al., 2011, “Topic Extraction Based on Wikipedia Category”, Proceedings of Computational Sciences and Optimization (CSO). The Wikipedia categories are also used as a reference in the YAGO ontology disclosed by document SUCHANEK F., et al, “YAGO: a core of semantic knowledge”, WWW 2007, pp. 697-706.

However, the methods known propose a thematic classification prone to categorization errors due to the rough processing of category data from the Wikipedia database. There is therefore a need for a method which is more robust and accurate than the existing methods.

### OBJECT OF THE INVENTION

The invention aims to meet this need by offering a thematic classification method for a digital text file from an encyclopedic database comprising a graph of categories defined by a set of category nodes having each an article linked thereto, a so-called generic category node being connected to no, one, or several more specific category nodes, characterized in that said method comprises, during a learning phase for developing a thematic classification model, the step of grouping, for each category node, all the articles directly linked to said category node so as to obtain for each category node a set of words called “bag of words”, determining a so-called term-frequency vector characteristic of the category node corresponding to the number of occurrences of each word in the bag of words, combining for each category node the term-frequency vector, which is directly connected thereto, with term-frequency vectors of more specific nodes, and in that it includes, during a production phase, the step of calculating the term-frequency vector of said digital text file and selecting in said thematic classification model N category nodes having the closest term-frequency vectors to the term-frequency vector of the digital text file.

The invention thus enables to process a given digital text file in a generic and automatic way, i.e. without previously imposing a learning phase specific to the field or language of the document. The invention enables to finely associate, with a given text written in a given language, categories in that language, which are preferably represented as a graph.

The use of a cross-language index in the database will enable in some embodiments to obtain a subset of these categories in other languages than that of the original text. This will make it possible to then authorize a cross-language search in the documents associated with a given set of topics.

According to one embodiment, the method further comprises the step of rebuilding a computational representation of the selected category nodes as a graph.

According to one embodiment, the method includes the step of suppressing possible cycles from the graph of categories so as to obtain a directed acyclic graph.

According to one embodiment, during the learning phase, a category node a number of articles below a threshold are associated with is merged with a more generic category node and the articles that were directly connected thereto are linked to said more generic category node.

According to one embodiment, the combination consists in adding the term-frequency vector of each category node, a so-called target node, to the term-frequency vectors of more specific category nodes directly connected to said target node, the so-called subcategory nodes, said subcategory nodes being weighted.

According to one embodiment, for a target node having M subcategory nodes, each term-frequency vector of a subcategory node is weighted with a factor 1/(M+1).

According to one embodiment, the term-frequency vector(s) of the closest N category nodes to the term-frequency vector of the digital text file is/are the vector(s) which maximize(s) the scalar product with the term-frequency vector of the digital text file.

According to one embodiment, said scalar product is weighted with the help of techniques of the TF.IDF and/or Okapi BM25 type.

According to one embodiment, the method comprises the step of classifying the digital text file according to categories in another language than that of the digital text file by means of a cross-language index associating, with a category node, its translations into other languages.

According to one embodiment, the method includes the step of suppressing low-relevance category nodes having a level inferior or equal to a threshold.

According to one embodiment, the encyclopedic database is the database “WIKIPEDIA” (registered trademark).

According to one embodiment, the encyclopedic database consists of consumer opinions grouped according to their categories.

### BRIEF DESCRIPTION OF THE FIGURES

The invention will be better understood from the following description and the annexed Figures. These Figures are given only as an illustration but in no way as a limitation of the invention.

FIG. 1 is a schematic representation of the different elements involved in the embodiment of the automatic classification method according to the invention;

FIG. 2 shows a diagram of the various steps of the automatic classification method according to the invention;

FIGS. 3a to 3f represent the various processing operations carried out on a graph of categories during a learning phase of the automatic classification method according to the invention;

FIGS. 4a to 4d show the various operations carried out on a graph of categories during a production phase of the automatic classification method according to the invention.

Identical, similar or analogous elements have the same references from one Figure to another.

### DESCRIPTION OF EMBODIMENTS OF THE INVENTION

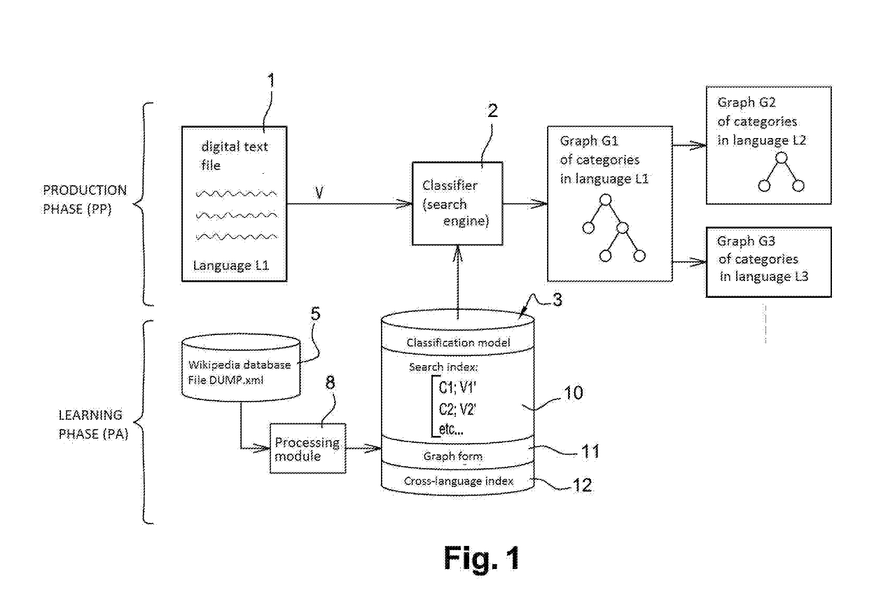

As shown in FIG. 1, the thematic classification method according to the invention enables to automatically provide a list of relevant categories corresponding to a digital text file 1. The list of relevant categories is preferably displayed in the form of a computational representation of a graph G1 in the language L1 corresponding to the language of the digital text file 1. This graph G1 will be translated, if appropriate, into several languages L2, L3, etc. so as to obtain the corresponding representations G2, G3, . . .

To this end, a classifier 2, preferably in the form of a search engine, uses a thematic classification model 3 providing a list of relevant categories according to the analyzed file 1.

More specifically, the thematic classification model 3 is developed through a learning process from an encyclopedic database 5 organized according to categories articles are linked to. To be specific, this database is the database “WIKIPEDIA” (registered trademark) processed as a file “dump.xml” by the module 8 but, alternatively, it could be any other equivalent database. Alternatively, the encyclopedic database consists of consumer opinions grouped according to categories.

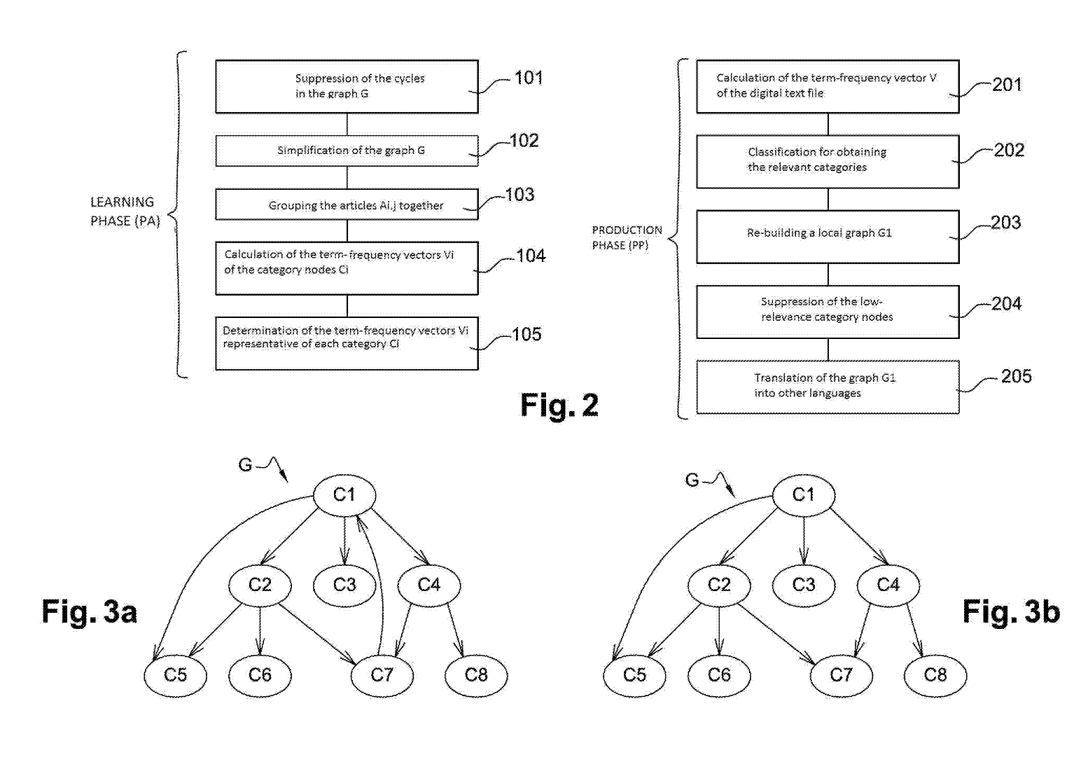

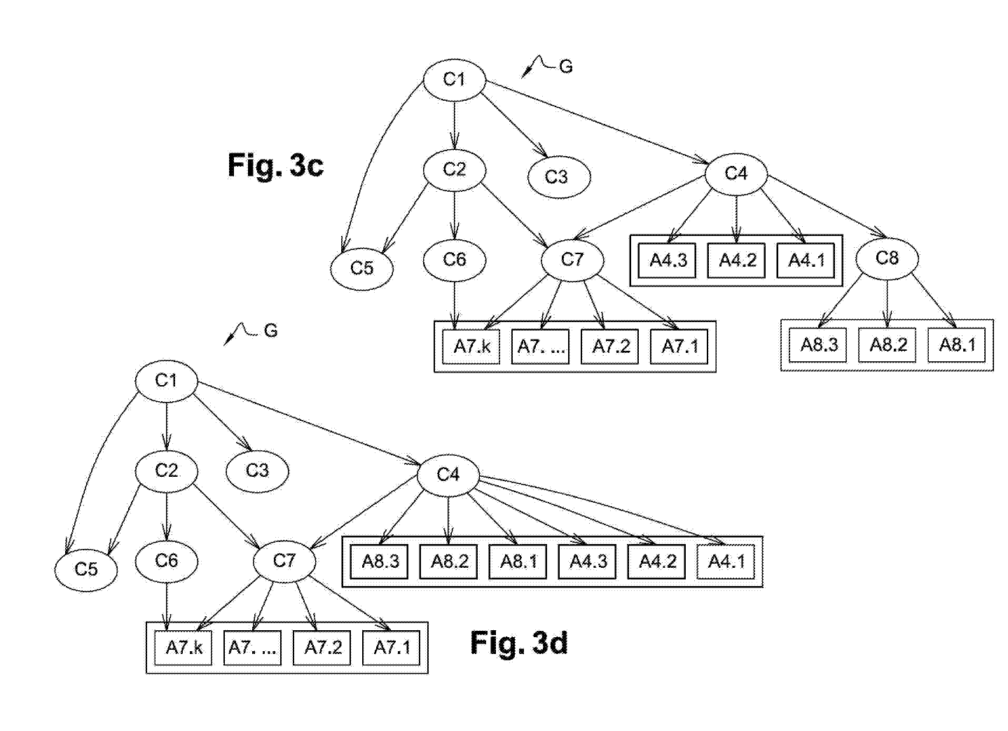

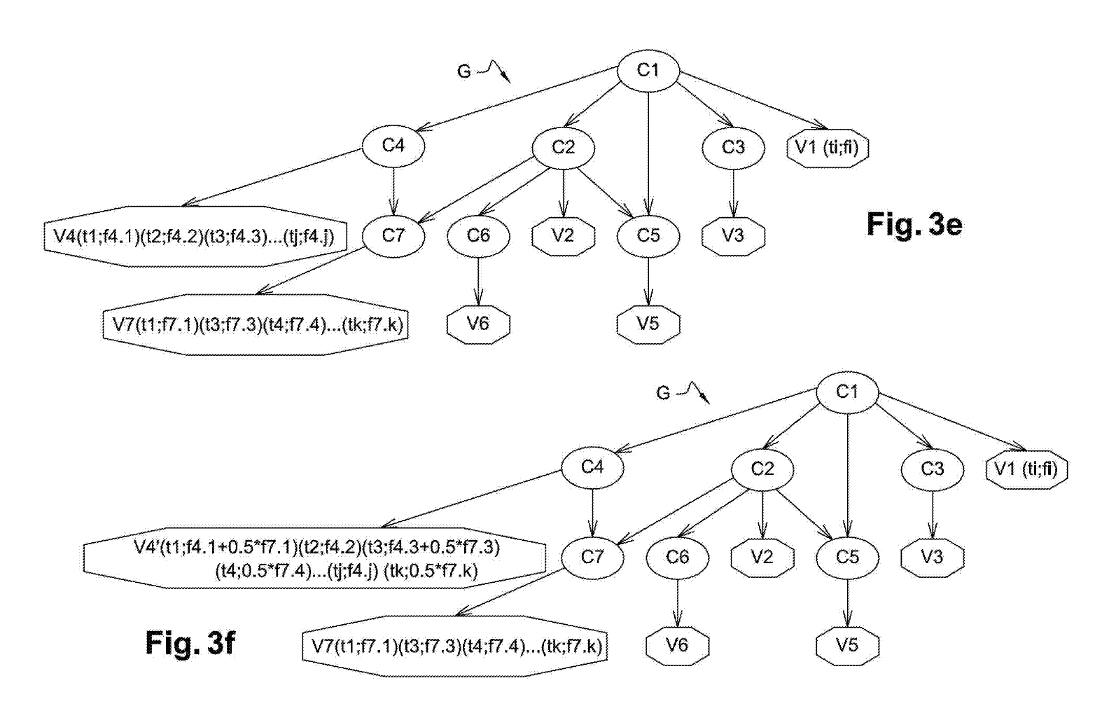

As shown in FIG. 3a, the encyclopedic database 5 comprises a graph G of categories represented in a simplified manner by a set of category nodes Ci having each an article Ai.j linked thereto, a so-called generic category node being connected by an arc to no, one, or several more specific category nodes than the generic category. As an example, the category “shoes” is more generic than the category “boots” or “sneakers” which are specific categories thereof.

To be specific, the generic category node C1 is connected to the specific category nodes C2, C3 and C4, which are generic category nodes relative to the specific category nodes C5, C6, C7 and C8. For a given category node, a so-called “incoming” arc comes from a more generic category node, while a so-called “outgoing” arc is connected to a specific category node. In the example shown, it will therefore be understood that the direction extends from the most generic category node to the most specific category node when moving from top to bottom. However, this representation is purely arbitrary and could have been reversed.

During a learning phase PA for developing the thematic classification model 3, the cycles of the graph of categories are suppressed in a step 101 so as to obtain a directed acyclic graph (DAG) G and thus to avoid infinite loops.

To this end, the implementation of the algorithm described in Tarjan (1972), “Depth-first search and linear graph algorithms”, SIAM Journal on Computing, Vol. 1, No. 2, p. 146-160 is preferred, which detects the strongly related areas of a directed graph with an in-depth exploration from the roots, i.e. the category nodes Ci without any incoming arc. An arc is then locally suppressed until all the cycles are suppressed. The choice of the arc to be suppressed is arbitrary and, in this case, the operation consists in selecting the arcs that connect the lowest category nodes Ci in the hierarchy. Thus, in the example shown, the cycle between the category nodes C7 and C1 is suppressed in order to obtain the graph G in FIG. 3b.

Moreover, during a step 102, a category node Ci, a number of articles below a threshold is associated with, is merged with the more generic category node Ci and the articles Ai.j, which were directly connected thereto, are linked to said more generic category node. In the example represented in FIGS. 3c and 3d, as the threshold of articles Ai.j linked to a category node Ci is three, the category node C8, which does not contain enough articles A8.1, A8.2, A8.3, is merged with its more generic category node C4 and the articles A8.1 and A8.3, which were directly connected thereto, rise up to said more generic category node C4.

For each category node, all the texts of the articles directly linked to the category node are grouped in a step 103 so as to obtain for each category a set of words called “bag of words”.

A so-called term-frequency vector Vi, characteristic of the category node Ci corresponding to the number of occurrences of each word in the “bag of words”, is determined in a step 104. Thus, as shown for example in FIG. 3e, the vector V4, associated with the category node C4, is defined by a term t1 having an occurrence f4.1, the term t2 having an occurrence f4.2, the term t3 having an occurrence f4.3 etc . . . , the term tk having an occurrence f4.k.

Beforehand, a search engine, such as the so-called engine “Lucene”, will process the texts in the articles according to a sequence of classical information research operations, such as segmentation of text into words, normalization of the type cases thereof, suppression of diacritics, suppression of grammatical words (“stop words” such as articles), stemming and term counting. The engine “Lucene” is particularly interesting in that these operations are proposed as a standard for thirty languages.

An exploration of the graph G is then carried out from the most generic roots to the most specific leaves having no outgoing arc, and during the recursive rise, in a step 105, at each category node Ci, the term-frequency vector Vi, which is directly connected thereto, is combined with term-frequency vectors of more specific category nodes Ci. The objective is to associate a representative term-frequency vector with each category node Ci. The combination is carried out so that the texts, directly linked to the category node, constitute a major contribution, while the texts linked to the more specific categories, constitute a minor contribution. In this case, the term-frequency vector Vi for each category node, the so-called target node, is added to the term-frequency vectors Vi for the more specific category nodes, directly connected to said target node, the so-called subcategory nodes Ci, the subcategory nodes being weighted. Term-frequency vectors are thus obtained, which are called optimized vectors Vi′.

Preferably, for a target node having M subcategory nodes, each term-frequency vector at a subcategory node is weighted with a damping factor (e.g. 1/(M+1)). Thus, as illustrated in FIG. 3f, in a first step of the recursive rise, the term-frequency vector V4 is replaced with the term-frequency vector V4′=V4+0.5*V7. It is specified that the vector V7 is weighted by 0.5 for there are M=1 subcategory nodes below C4, so that the linear combination factor is 1/((M=1)+1)=0.5. The operations are thus repeated until the rise through the graph is over.

The categories Ci and their optimized term-frequency vector Vi′ are indexed in a search index 10 stored in the classification model 3.

During a production phase PP, the term-frequency vector V of the digital text file 1 to be categorized is calculated in a step 201 in the same way as the term-frequency vector Vi of the articles Ai.j directly linked to a category Ci was calculated.

The actual classification is carried out by performing in a step 202 a search through the search index 10 previously formed by means of the search engine 2, which then returns the “flat” list of the N most relevant categories, i.e. those having the closest optimized term-frequency vector Vi to the term-frequency vector V of the text. N can be determined by the user and is typically comprised between 5 and 30. The “flat” list of categories indicates those categories that are not hierarchically organized as a graph insofar as the categories are not hierarchically organized as a graph in the search index 10.

Preferably, it is considered that the optimized term-frequency vectors Vi′ of the closest categories to the terms-frequency vector V for the digital text file are those that maximize the scalar product between the term-frequency vector V and the optimized term-frequency vector Vi′ of a category Ci. Preferably, the scalar product is weighted with by means of techniques of TF.IDF and/or Okapi BM25 type.

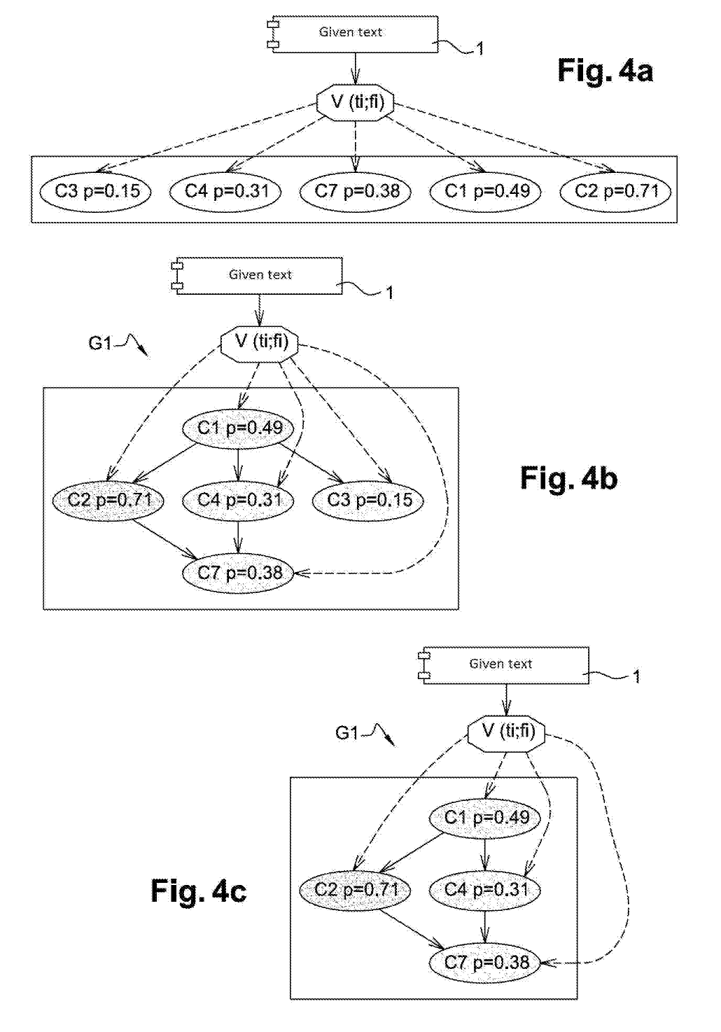

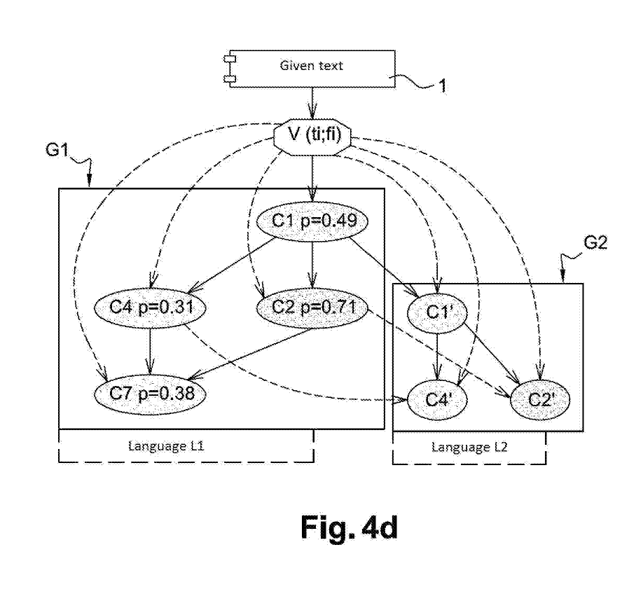

Thus, as shown in FIG. 4a, the digital text file 1 will be associated with the category nodes C3, C4, C7, C1, C2, the parameter “p” corresponding to the level of relevance for each category node.

In a step 203, the local graph shown in FIG. 4b is reconstituted from the categories found by the search engine 2 when using the form of the graph of categories. This form of the graph of categories corresponds to the piece of information 11 about the arcs connecting the category nodes which was previously stored in the classification model when generating the search index 10.

In the graph G1, it will be possible to adapt the display color of the category nodes Ci to their relevance “p”, the most relevant category nodes having a darker display while the less relevant category nodes have a clearer display.

In a step 204, the topology of the graph is used to suppress the low-relevance category nodes Ci that are not very much connected to others, such as the nodes of level 1, i.e. those having one or no arc. In the example in FIG. 4c, the category node C3 was thus suppressed.

If the encyclopedic database 5 contains a cross-language index 12 which associates a category node Ci with its translations Ci′, Ci″, etc . . . into other languages, the use of this index 12 by the classification model 3 enables to directly establish in a step a classification of the text file according to categories in another language L2-L3.

Thus, as shown in FIG. 4d, the category nodes C1′ C2′ C4′ in the graph G2 correspond to the translation into another language L2 of the initial category nodes C1, C2, C4 in the language L1 while there is no correspondence for the category node C7 in the other language L2. Indeed, it should be noted that a completeness of the cross-language index 12 is random and varies according to the category nodes Ci. For those considered important by users, links are provided to a large number of languages; however, there will be sometimes no link for too fine a category or for a category of secondary interest.

Of course, it will possible for a skilled person to modify the above-described method. Thus, alternatively, it will possible to use techniques such as HMM (Hiden Markov Model) or SVM (Support Vector Machine) or maximum entropy or neural network for the classifier.

1-12. (canceled)

13. Automatic thematic classification method for a digital text file from an encyclopedic database, comprising a graph of categories defined by a set of category nodes, each category node having an article linked thereto, a generic category node is connected to none, one, or several more specific category nodes, the method comprises the steps of:
during a learning phase for developing a thematic classification model, grouping, for each category node, all articles directly linked to said each category node to obtain a set or bag of words for said each category node; determining a term-frequency vector characteristic of said each category node corresponding to a number of occurrences of each word in the bag of words; combining at said each category node the term-frequency vector, directly connected thereto, with term-frequency vectors of more specific nodes; and
during a production phase, calculating the term-frequency vector of the digital text file and selecting N category nodes, in the thematic classification model, having closest term-frequency vectors to the term-frequency vector of the digital text file.

14. The method according to claim 13, further comprising the step of reconstituting a computational representation as a graph of the selected N category nodes.

15. The method according to claim 13, further comprising the step of suppressing cycles from the graph of categories to obtain a directed acyclic graph.

16. The method according to claim 13, wherein, during the learning phase, a category node with a number of articles below a threshold is merged with a more generic category node and the articles linked to the category node are linked to the more generic category node.

17. The method according to claim 13, wherein the step of combining comprises the step of adding the term-frequency vector of a target node to the term-frequency vectors of subcategory nodes directly connected to the target node, the subcategory nodes being weighted.

18. The method according to claim 17, further comprising the step of weighting each term-frequency vector of a sub-category node with a factor 1/(M+1) for a target node having M subcategory nodes.

19. The method according to claim 13, wherein the term-frequency vectors of closest N category nodes to the term-frequency vector of the digital text file are those maximizing a scalar product with the term-frequency vectors of the text file digital.

20. The method according to claim 19, wherein the scalar product is weighted with at least one of frequency-inverse document frequency or TF.IDF and Okapi BM25 type.

21. The method according to claim 13, further comprising the step of classifying the digital text file according to categories in another language than that of the digital text file by a cross-language index associating a category node with translations of the category node into other languages.

22. The method according to claim 14, further comprising the step of suppressing low-relevance category nodes having a level inferior or equal to a threshold.

23. The method according to claim 13, wherein the encyclopedic database is a free web-based database collaboratively written by people who use the encyclopedic database.

24. The method according to claim 13, wherein the encyclopedic database comprises consumer opinions grouped according to categories.
